(19) United States
(12) Patent Application Publication
(10) Pub. No.: US 2026/0186958 A1
(43) Pub. Date: Jul. 2, 2026

(54) FLEXIBLE BACKGROUND DATA REFRESH ARCHITECTURE

(71) Applicant: SK Hynix NAND Product Solutions Corp. (dba Solidigm), Rancho Cordova, CA (US)

(72) Inventors: David Pelster, Longmont, CO (US); Mark Anthony Golez, Folsom, CA (US); Holman Su, Sacramento, CA (US); Teena Sebastian, Newark, CA (US)

(21) Appl. No.: 19/006,091

(22) Filed: Dec. 30, 2024

(51) Int. Cl. G06F 12/02

(52) U.S. Cl. CPC G06F 12/0246

(57) ABSTRACT

Devices and related methods for performing background data refresh (BDR) are provided herein, where the device includes (1) memory with a plurality of memory bands and (2) processing circuitry. The processing circuitry is configured to determine information about each memory band of the plurality of memory bands, to determine an available bandwidth, determine a target refresh rate, and to determine one or more memory partitions to be relocated based on the information and the target refresh rate. The processing circuitry is further configured to cause one or more memory partitions to be relocated in the memory based on the available bandwidth.

### TECHNICAL FIELD

The present disclosure is directed to devices and methods for performing background data refresh (BDR) on memory partitions of the devices.

### SUMMARY

In accordance with the present disclosure, devices, and methods for performing BDR on memory partitions (e.g., memory bands or virtual blocks) are provided to enable at least two modes, such as block mode and Flexible Data Placement mode, that may be used on the devices (e.g., a solid-state drive (SSD) device) while balancing (1) refreshing the data of memory partitions to avoid read errors, and (2) not refreshing the data of memory partitions too often to reduce wear on the memory blocks. The device provided herein includes processing circuitry and memory with one or more memory bands, each spanning one or more memory die. The processing circuitry is configured to determine information about each memory band of the memory. The processing circuitry is further configured to determine an available bandwidth and determine a target refresh rate (e.g., according to device requirements or preconfigured memory policies). The processing circuitry determines one or more memory partitions (e.g., a memory band when the device is in block mode, or a virtual block when the device is in FDP mode) to be relocated based on the determined information and the target refresh rate. The processing circuitry then relocates one or more memory partitions in the memory based on the available bandwidth. This enables the device to function using at least two modes, such as a block mode and FDP mode, that may be used on the devices (e.g., an SSD device) while balancing a data refresh rate to satisfy a target refresh rate.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 shows an illustrative diagram of a system including a device with processing circuitry and memory, in accordance with some embodiments of the present disclosure;

FIG. 2 shows an illustrative diagram that shows memory bands for memory dies of a device similar to that of FIG. 1, in accordance with some embodiments of the present disclosure;

FIG. 3 shows an illustrative diagram that shows virtual blocks for memory dies of a device similar to that of FIG. 1, in accordance with some embodiments of the present disclosure;

FIG. 4 shows an illustrative diagram of processing circuitry of a device similar to that of FIG. 1, in accordance with some embodiments of the present disclosure; and

FIG. 5 shows a flowchart of illustrative steps of a process for performing background data refresh (BDR) for a device similar to that of FIG. 1, in accordance with some embodiments of the present disclosure.

### DETAILED DESCRIPTION

In accordance with the present disclosure, devices and methods for performing BDR on memory partitions (e.g., memory bands or virtual blocks) are provided to enable at least two modes, such as block mode and Flexible Data Placement mode, that may be used on the devices (e.g., an SSD device) while balancing (1) refreshing the data of memory partitions to avoid read errors, and (2) not refreshing the data of memory partitions too often to reduce wear on the memory blocks.

The processing circuitry is configured to perform BDR on one or more memory partitions (e.g., memory bands in block mode or virtual blocks in FDP mode). In some embodiments, processing circuitry is configured to determine information indicative of states or characteristics of the memory bands of memory (e.g., NAND memory). The determined information may include any one or more of the age of data stored in the memory bands, a type of the data stored in the memory bands, a maximum number of cycles for the respective memory, or any suitable parameters or statistics indicative of a degree of data degradation of one or more memory bands, or a combination thereof. In some embodiments, processing circuitry may maintain band status information for each respective memory band of memory, where the band status information is indicative of whether a memory band is (1) an open memory band, (2) a closed memory band, or (3) any other suitable band status that may be stored in the bands library. Processing circuitry is configured to access the data stored in memory blocks. In some embodiments, the processing circuitry is configured to periodically (e.g., at a configured clock frequency) determine metadata for each memory band. In some embodiments, processing circuitry determines (1) the age of certain memory blocks of a respective memory band, (2) the maximum cycle lifetime of the memory blocks of the respective memory band before a refresh may be mandated, or (3) a type of data stored in the respective memory band based on the metadata of the respective memory band. In some embodiments, processing circuitry determines a score based on the determined age of certain memory blocks of the memory band, a maximum cycle lifetime of the memory blocks of the memory band before a refresh may be mandated, or a type of data stored in the memory bands, or any other suitable parameters or statistics indicative of a degree of data degradation in the memory bands of memory. The determined information (e.g., score) of a respective memory band may be indicative of whether the respective memory partition is a candidate for BDR. The processing circuitry may determine to perform BDR on a memory partition (e.g., a memory band in block mode or virtual blocks in FDP mode) according to the determined information (e.g., score).

The processing circuitry is also configured to update, manage, and allocate the amount of bandwidth to perform tasks, operations, or commands by processing circuitry, including operations for memory management (e.g., BDR and garbage collection). The processing circuitry may determine the amount of bandwidth that would be needed to perform BDR on the determined memory partition candidates. In some embodiments, processing circuitry may determine the amount of bandwidth needed to perform BDR on the determined memory partition candidates based on (1) the corresponding amount of data that would be relocated, (2) the timing requirements of the device, or (3) any preconfigured memory degradation policy (e.g., target refresh rate, NAND policy) requirements, or any combination thereof. When processing circuitry determines that there is available bandwidth to perform BDR, the amount of available bandwidth allocated to BDR is determined based on the amount of bandwidth needed to perform BDR on the determined memory partition candidates and the total amount of available bandwidth for the processing circuitry. In some embodiments, processing circuitry may deny the allocation of bandwidth to perform BDR if there are higher priority tasks or operations for processing circuitry to perform.

When processing circuitry allocates an amount of available bandwidth to perform BDR on memory partitions (e.g., memory bands in block mode or virtual blocks in FDP mode), processing circuitry may issue credits for each memory partition on which BDR is to be performed. In some embodiments, processing circuitry determines the number of credits for each respective memory partition based on (1) the amount of allocated bandwidth for BDR, (2) the number of memory partitions (e.g., memory bands or virtual blocks) on which BDR is to be performed, (3) the size of the memory partition on which BDR is to be performed, (4) whether the device is in block mode or FDP mode, and (5) preconfigured memory degradation policy (e.g., target refresh rate, NAND policy) requirements. Once the processing circuitry has identified the memory partition candidates and issued credits for each memory partition on which BDR is to be performed, the processing circuitry may then perform BDR on the memory partition candidates by relocating the data stored within the memory partition candidates to a different memory location within the memory. When the device is in block mode, the processing circuitry may relocate the memory partition (e.g., a memory band of data) to a memory address of a new memory band. When the device is in FDP mode, the processing circuitry may relocate the memory partition (e.g., virtual blocks of data) to one or more memory blocks across different memory bands and different memory dies of memory. The processing circuitry is configured to, based on whether the device is in block mode or FDP mode, calculate the amount of data within a memory partition, whether the memory partition corresponds to a memory band in block mode or a virtual block in FDP mode.

In some embodiments, the memory of the device disclosed herein may contain any of the following memory densities: single-level cells (SLCs), multi-level cells (MLCs), triple-level cells (TLCs), quad-level cells (QLCs), penta-level cells (PLCs), and any suitable memory density that is greater than five bits per memory cell.

For purposes of brevity and clarity, the features of the disclosure described herein are in the context of a device (e.g., an SSD device) having processing circuitry and memory. However, the principles of the present disclosure may be applied to any other suitable context in which BDR may be performed on memory partitions (e.g., memory bands when the device is in block mode or virtual blocks when the device is in FDP mode). The device may include processing circuitry and memory communicatively coupled to each other by a network bus or interface.

In some embodiments, a processor of the processing circuitry may be a highly parallelized processor capable of handling high bandwidths of incoming data quickly (e.g., by starting simultaneous processing of requests or instructions before completion of previously received requests or instructions).

In some embodiments, the devices and methods of the present disclosure may refer to a storage device (e.g., an SSD storage device), which includes a storage device memory such as a solid-state drive device memory, which is communicatively coupled to the processing circuitry by a network bus or interface.

An SSD is a data storage device that uses integrated circuit assemblies as memory to store data persistently. SSDs have no moving mechanical components, and this feature distinguishes SSDs from traditional electromechanical magnetic disks, such as hard disk drives (HDDs) or floppy disks, which contain spinning disks and movable read/write heads. Compared to electromechanical disks, SSDs are typically more resistant to physical shock, run silently, have lower access time, and less latency.

Many types of SSDs use NAND-based flash memory which retains data without power and includes a type of non-volatile storage technology. Quality of Service (QoS) of an SSD may be related to the predictability of low latency and consistency of high input/output operations per second (IOPS) while servicing read/write input/output (I/O) workloads. This means that the latency or the I/O command completion time needs to be within a specified range without having unexpected outliers. The throughput or I/O rate may also need to be tightly regulated without causing sudden drops in performance levels.

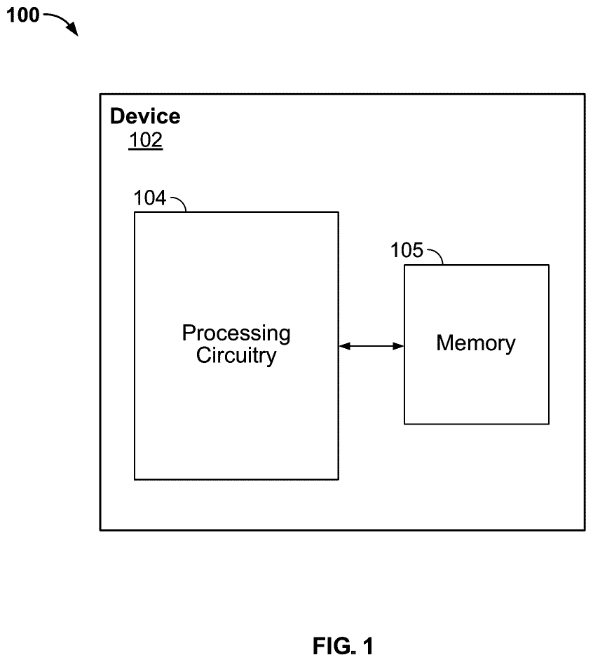

The subject matter of this disclosure may be better understood by reference to FIGS. 1-5.

FIG. 1 shows an illustrative diagram of a system 100 including a device 102 with processing circuitry 104 and memory 105, in accordance with some embodiments of the present disclosure. In some embodiments, device 102 may be a storage device such as a solid-state storage device (e.g., an SSD device). In some embodiments, processing circuitry 104 may include a processor or any suitable processing unit. In some embodiments, memory 105 may be non-volatile memory. It will be understood that the embodiments of the present disclosure are not limited to SSDs. For example, in some embodiments, system 100 may include a hard disk drive (HDD) device in addition to or in place of an SSD device.

Additionally, device 102 includes memory 105. In some embodiments, memory 105 includes any one or more of a non-volatile memory, such as Phase Change Memory (PCM), a PCM and switch (PCMS), a Ferroelectric Random Access Memory (FeRAM), or a Ferroelectric Transistor Random Access Memory (FeTRAM), a Memristor, a Spin-Transfer Torque Random Access Memory (STT-RAM), and a Magnetoresistive Random Access Memory (MRAM), any other suitable memory, or any combination thereof. In some embodiments, memory 105 is of a memory density, which may be any one of (a) single-level cell (SLC) memory density, (b) multi-level cell (MLC) memory density, (c) tri-level cell (TLC) memory density, (d) quad-level cell (QLC) memory density, (e) penta-level cell (PLC) memory density, or (f) a memory density of greater than 5 bits per memory cell. In some embodiments, processing circuitry 104 is communicatively coupled to memory 105 to store and access data in memory blocks. In some embodiments, memory 105 includes one or more memory dies. In some embodiments, when device 102 is in block mode, memory 105 is partitioned into one or more memory bands, where each memory band includes a row of memory blocks across each of the memory dies. In some embodiments, memory 105 includes at least one memory die and therefore each memory band includes at least one memory block. In some embodiments, a data bus interface is used to transport write/read/relocate requests or data associated with BDR or any other suitable memory management. The data bus between memory 105 and processing circuitry 104 provides a network bus for accessing or writing data to memory 105 (e.g., any memory block of memory 105). In some embodiments, memory 105 may include memory partitions, which may be (1) a memory band or multiple memory blocks across all memory dies when the device 102 is in block mode, or (2) a virtual block, or one or more memory block across multiple memory bands and memory dies when the device 102 is in FDP mode.

In some embodiments, device 102 also includes volatile memory, which may include any one or more volatile memory, such as Static Random Access Memory (SRAM). In some embodiments, volatile memory is configured to temporarily store data (e.g., request data) during the execution of operations by processing circuitry 104. In some embodiments, processing circuitry 104 is communicatively coupled to volatile memory to store and access data corresponding to the volatile memory. In some embodiments, a data bus interface is used to transport request data from volatile memory to processing circuitry 104. In some embodiments, volatile memory is communicatively coupled to memory 105, the volatile memory configured to function as a cache or temporary memory storage for memory 105. In some embodiments, a data bus interface between memory 105 and volatile memory provides a network bus for accessing or writing data to or from memory 105.

In some embodiments, the processor or processing unit of processing circuitry 104 may include a hardware processor, a software processor (e.g., a processor emulated using a virtual machine), or any combination thereof. The processor, also referred to herein as processing circuitry 104, may include any suitable software, hardware, or both for controlling memory 105 and processing circuitry 104. In some embodiments, device 102 may further include a multi-core processor. Memory 105 may also include hardware elements for non-transitory storage of instructions, commands, or requests.

The processing circuitry 104 is configured to perform BDR on one or more memory partitions (e.g., memory bands in block mode or virtual blocks in FDP mode). In some embodiments, processing circuitry 104 is configured to determine information indicative of states or characteristics of the memory bands of memory 105 (e.g., NAND memory). The determined information may include any one or more of the age of data stored in the memory bands, a type of the data stored in the memory bands, a maximum number of cycles for the respective memory, or any suitable parameters or statistics indicative of a degree of data degradation of one or more memory bands, or a combination thereof. In some embodiments, processing circuitry 104 may maintain band status information for each respective memory band of memory 105, where the band status information is indicative of whether a memory band is (1) an open memory band, (2) a closed memory band, or (3) any other suitable band status that may be stored in the bands library. Processing circuitry 104 is configured to access the data stored in memory blocks of memory 105. In some embodiments, processing circuitry 104 is configured to periodically (e.g., at a configured clock frequency) determine metadata for each memory band. In some embodiments, processing circuitry 104 determines (1) the age of certain memory blocks of a respective memory band, (2) the maximum cycle lifetime of the memory blocks of the respective memory band before a refresh may be mandated, or (3) a type of data stored in the respective memory band based on the metadata of the respective memory band. In some embodiments, processing circuitry determines a score based on the determined age of certain memory blocks of the memory band, a maximum cycle lifetime of the memory blocks of the memory band before a refresh may be mandated, or a type of data stored in the memory bands, or any other suitable parameters or statistics indicative of a degree of data degradation in the memory bands of memory 105. The determined information (e.g., score) of a respective memory band may be indicative of whether the respective memory partition is a candidate for BDR. Processing circuitry 104 may determine to perform BDR on a memory partition (e.g., a memory band in block mode or virtual blocks in FDP mode) according to the determined information (e.g., score).

Processing circuitry 104 is also configured to update, manage, and allocate the amount of bandwidth to perform tasks, operations, or commands by processing circuitry 104, including operations for memory management (e.g., BDR and garbage collection). The processing circuitry 104 may determine the amount of bandwidth that would be needed to perform BDR on the determined memory partition candidates. In some embodiments, processing circuitry 104 may determine the amount of bandwidth needed to perform BDR on the determined memory partition candidates based on (1) the corresponding amount of data that would be relocated, (2) the timing requirements of device 102, or (3) any preconfigured memory degradation policy (e.g., target refresh rate, NAND policy) requirements, or any combination thereof. When processing circuitry 104 determines that there is available bandwidth to perform BDR, the amount of available bandwidth allocated to BDR is determined based on the amount of bandwidth needed to perform BDR on the determined memory partition candidates and the total amount of available bandwidth for the processing circuitry 104. In some embodiments, processing circuitry 104 may deny the allocation of bandwidth to perform BDR if there are higher priority tasks or operations for processing circuitry 104 to perform.

When processing circuitry 104 allocates an amount of available bandwidth to perform BDR on memory partitions (e.g., memory bands in block mode or virtual blocks in FDP mode), processing circuitry may issue credits for each memory partition on which BDR is to be performed. In some embodiments, processing circuitry 104 determines a number of credits for each respective memory partition based on (1) the amount of allocated bandwidth for BDR, (2) the number of memory partitions (e.g., memory bands or virtual blocks) on which BDR is to be performed, (3) the size of the memory partition on which BDR is to be performed, (4) whether the device 102 is in block mode or FDP mode, and (5) preconfigured memory degradation policy (e.g., target refresh rate, NAND policy) requirements. Once the processing circuitry 104 has identified the memory partition candidates and issued credits for each memory partition on which BDR is to be performed, the processing circuitry 104 may then perform BDR on the memory partition candidates by relocating the data stored within the memory partition candidates to a different memory location within memory 105. When device 102 is in block mode, the processing circuitry may relocate the memory partition (e.g., a memory band of data) to a memory address of a new memory band. When device 102 is in FDP mode, the processing circuitry 104 may relocate the memory partition (e.g., virtual blocks of data) to one or more memory blocks across different memory bands and different memory dies of memory 105. The processing circuitry 104 is configured to, based on whether the device 102 is in block mode or FDP mode, calculate the amount of data within a memory partition, whether the memory partition corresponds to a memory band in block mode or a virtual block in FDP mode.

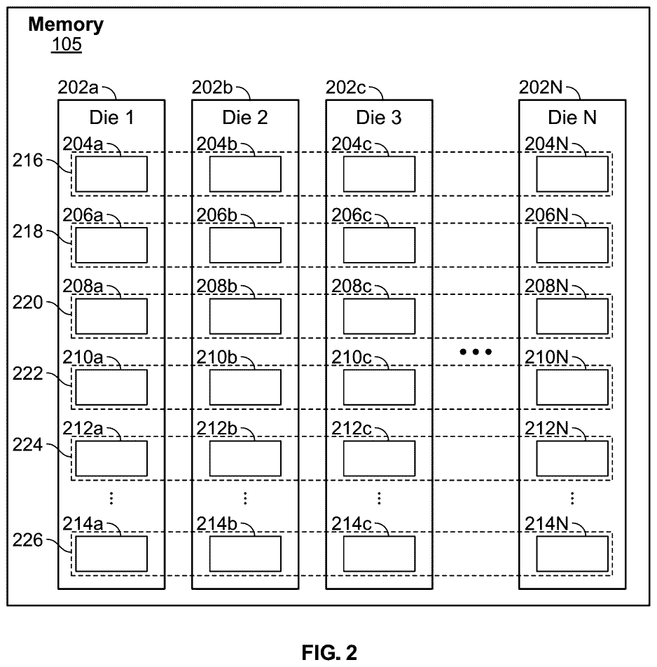

FIG. 2 shows an illustrative diagram that shows memory bands (e.g., memory bands 216, 218, 220, 222, 224, 226) for memory dies (e.g., memory dies 202a, 202b, 202c, 202N) of a device 102 similar to that of FIG. 1, in accordance with some embodiments of the present disclosure. Memory 105 includes memory dies (e.g., first die 202a, second die 202b, third die 202c, and Nth die 202N). In addition, memory 105 may be organized into memory bands (e.g., first memory band 216, second memory band 218, third memory band 220, fourth memory band 222, fifth memory band 224, and Nth memory band 226). Although memory 105 shown in FIG. 2 includes four memory dies and six memory bands, memory 105 may include any suitable number of memory dies and any suitable number of memory bands to store data. Therefore, each memory band (e.g., memory bands 216, 218, 220, 222, 224, 226) includes more than four memory blocks (e.g., first memory block 204a, second memory block 204b, second memory block 204c, and fourth memory block 204N). In some embodiments, memory 105 includes any one or more of a non-volatile memory, such as Phase Change Memory (PCM), a PCM and switch (PCMS), a Ferroelectric Random Access Memory (FeRAM), or a Ferroelectric Transistor Random Access Memory (FeTRAM), a Memristor, a Spin-Transfer Torque Random Access Memory (STT-RAM), and a Magnetoresistive Random Access Memory (MRAM), any other suitable memory, or any combination thereof. In some embodiments, memory 105 is of a memory density, the memory density is any one of (a) single-level cell (SLC) memory density, (b) multi-level cell (MLC) memory density, (c) tri-level cell (TLC) memory density, (d) quad-level cell (QLC) memory density, (e) penta-level cell (PLC) memory density, or (f) a memory density of greater than 5 bits per memory cell. In some embodiments, processing circuitry 104 is communicatively coupled to memory 105 to store and access data in memory blocks (e.g., memory blocks 204a-204N, 206a-206N, 208a-208N, 210a-210N, 212a-212N, 214a-214N). In some embodiments, when device 102 is in block mode, memory 105 is partitioned into one or more memory bands (e.g., memory bands 216, 218, 220, 222, 224, 226), where each memory band includes a row of memory blocks across each of the memory dies (e.g., memory dies 202a, 202b, 202c, 202N). For example, memory band 216 is defined as including first memory block 204a of first memory die 202a, second memory block 204b of second memory die 202b, third memory block 204c of third memory die 202c, and fourth memory block 204N of Nth memory die 202N. In some embodiments, a data bus interface is used to transport write/read/relocate requests or data associated with BDR or any other suitable memory management operations. The data bus between memory 105 and processing circuitry 104 provides a network bus for accessing or writing data to memory 105 (e.g., any memory block of memory 105). When device 102 is in block mode, a memory partition may be a memory band.

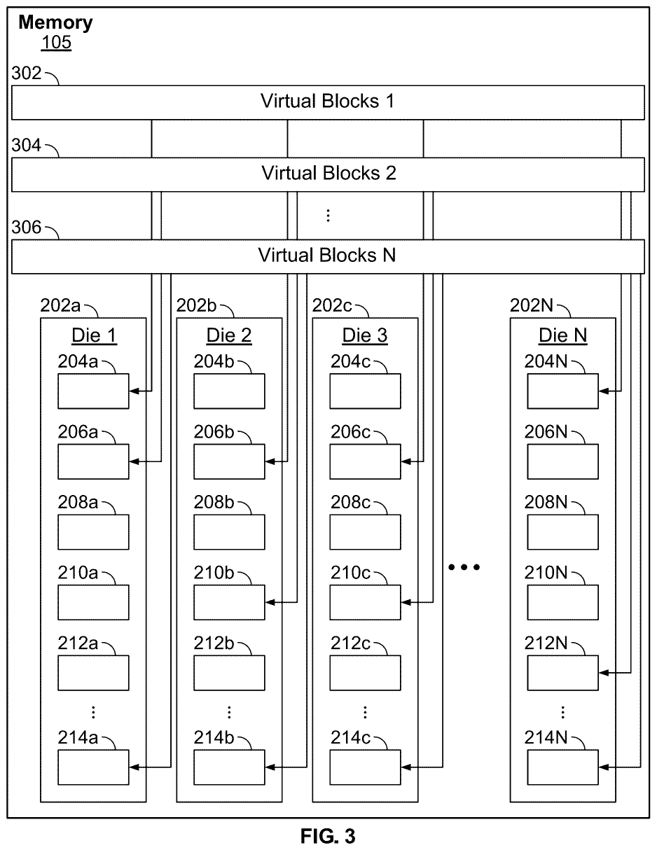

FIG. 3 shows an illustrative diagram that shows virtual blocks for memory dies of a device similar to that of FIG. 1, in accordance with some embodiments of the present disclosure. Memory 105 includes memory dies (e.g., first die 202a, second die 202b, third die 202c, and Nth die 202N). Memory 105 may be organized into virtual blocks (e.g., first virtual block pool 302, second virtual block pool 304, and Nth virtual block pool 306). Although memory 105 shown in FIG. 3 includes four memory dies and three virtual blocks, memory 105 may include any suitable number of memory dies and any suitable number of virtual blocks to store data. In some embodiments, each respective one of the virtual blocks (e.g., first virtual block pool 302, second virtual block pool 304, and Nth virtual block pool 306) include one or more memory blocks (e.g., memory blocks 204a-204N, 206a-206N, 208a-208N, 210a-210N, 212a-212N, 214a-214N) from any memory dies (e.g., first die 202a, second die 202b, third die 202c, or Nth die 202N). For example, first virtual block pool 302 includes memory blocks 204a, 206b, 206c, and 204N, second virtual block pool 304 includes memory blocks 206a, 210b, 210c, and 212N, and Nth virtual block pool 306 includes memory blocks 214 a, 214 b, 214 c, and 214N. In some embodiments, virtual blocks may include one or more memory blocks from the same memory die. In some embodiments, when device 102 is in FDP mode, memory 105 is partitioned into one or more virtual blocks (e.g., virtual block pools 302, 304, 306). In some embodiments, a data bus interface is used to transport write/read/relocate requests or data associated with BDR or any other suitable memory management operations. The data bus between memory 105 and processing circuitry 104 provides a network bus for accessing or writing data to memory 105 (e.g., any memory block of memory 105). When device 102 is in FDP mode, a memory partition may include virtual blocks.

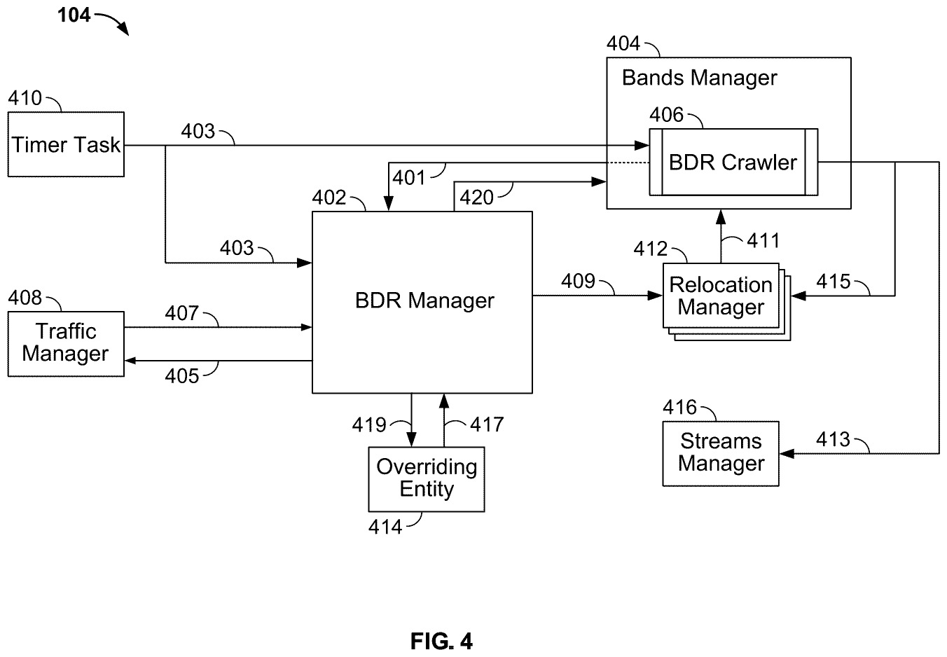

FIG. 4 shows an illustrative diagram of processing circuitry 104 of a device similar to that of FIG. 1, in accordance with some embodiments of the present disclosure. By periodically rewriting data of memory portions, a storage device ensures that the respective stored data is refreshed and may be reliably accessed by the storage device. As an example, once data is stored at a memory location in NAND memory, the data may gradually degrade over time. Memory management functions, such as BDR, are used by the storage device with memory (e.g., NAND memory) to rewrite portions of the memory (e.g., one or more memory blocks of the NAND memory) after a time period to ensure reliable data storage.

As shown in FIG. 4, processing circuitry 104 may include a BDR manager 402, which may be communicatively coupled to a bands manager 404, relocation manager 412, an overriding entity 414 (e.g., a host device), a traffic manager 408, and a timer task 410. The processing circuitry may also include a streams manager 416 and a BDR crawler 406, which may be a part of bands manager 404.

The BDR manager 402 is configured to receive information 401 from the bands manager 404, where information 401 is indicative of states or characteristics of the memory bands (e.g., memory bands 216, 218, 220, 222, 224, and 226) of memory 105 (e.g., NAND memory). Information 401 may include any one or more of the age of data stored in the memory bands, a type of the data stored in the memory bands, a maximum number of cycles for the respective memory, or any suitable parameters or statistics indicative of a degree of data degradation of one or more memory bands, or a combination thereof. In some embodiments, processing circuitry 104 may also include a bands library (not shown in FIG. 4), which is communicatively coupled to BDR manager 402. The bands library may maintain band status information for each respective memory band of memory 105, where the band status information is indicative of whether a memory band is (1) an open memory band, (2) a closed memory band, or (3) any other suitable band status that may be stored in the bands library.

Processing circuitry 104 also includes bands manager 404, which has access to the data stored in memory blocks of memory bands (e.g., memory bands 216, 218, 220, 222, 224, and 226) of memory 105. In some embodiments, bands manager 404 includes BDR crawler 406, which is configured to periodically (e.g., at a configured clock frequency according to the receipt of clock signal 403 from timer task 410) determine metadata for each memory band (e.g., memory bands 216, 218, 220, 222, 224, and 226). In some embodiments, BDR crawler 406 determines the metadata of each memory band by sequentially polling each memory band (e.g., memory bands 216, 218, 220, 222, 224, and 226) of memory 105. In some embodiments, the bands manager 404 determines (1) the age of certain memory blocks of a respective memory band, (2) the maximum cycle lifetime of the memory blocks of the respective memory band before a refresh may be mandated, or (3) a type of data stored in the respective memory band based on the metadata of the respective memory band determined by the BDR crawler 406. In some embodiments, information 401 may refer to a score calculated by bands manager 404 based on the determined age of certain memory blocks of the memory band, a maximum cycle lifetime of the memory blocks of the memory band before a refresh may be mandated, or a type of data stored in the memory bands, or any other suitable parameters or statistics indicative of a degree of data degradation in the memory bands of memory 105. Information 401 of a respective memory band received by BDR manager 402 may be indicative of whether the respective memory partition is a candidate for BDR. The BDR manager 402 may determine to perform BDR on the respective memory band according to the information 401 received from bands manager 404. For example, if the score (e.g., based on information 401) associated with memory band 222 is the greatest score value relative to the scores (e.g., based on information 401) associated with the other memory bands (e.g., memory bands 216, 218, 220, 224, and 226), the BDR manager 402 may prioritize performing BDR on memory band 222.

Processing circuitry may also include timer task 410, which sends a clock signal 403 to each of the BDR manager 402 and BDR crawler 406. The timer task 410 may transmit clock signal 403 after each lapse of a timer configured with a time period (e.g., 3 milliseconds (ms)) or frequency (e.g., 333 Hz). When BDR manager 402 receives clock signal 403, the BDR manager 402 may be configured to determine which memory partitions (e.g., memory bands 216, 218, 220, 222, 224, and 226 or virtual block pools 302, 304, 306) of memory 105 are candidates on which BDR is to be performed based on the information 401, band status information received from bands library, or a combination thereof. The BDR manager 402 may then determine an available bandwidth by transmitting an available bandwidth request 405 to the traffic manager 408.

Traffic manager 408 is configured to update, manage, and allocate the amount of bandwidth to perform tasks, operations, or commands by the processing circuitry 104, including operations for memory management (e.g., BDR and garbage collection). Therefore, traffic manager 408 is configured to receive available bandwidth requests 405 from BDR manager 402 and transmit an available bandwidth response 407 to the BDR manager 402. The available bandwidth request 405 may include an amount of bandwidth that may be needed to perform BDR on the determined memory partition candidates. In some embodiments, BDR manager 402 may determine the amount of bandwidth needed to perform BDR on the determined memory partition candidates based on (1) the corresponding amount of data that would be relocated, (2) the timing requirements of device 102, or (3) any preconfigured memory degradation policy (e.g., target refresh rate, NAND policy) requirements, or any combination thereof. The available bandwidth response 407 may be (1) a response granting an amount of available bandwidth to be allocated for BDR, or (2) a response denying the allocation of bandwidth to BDR. When the available bandwidth response 407 is a response granting available bandwidth for BDR, the amount of available bandwidth included within the available bandwidth response 407 is determined by traffic manager 408 based on the available bandwidth request 405 (e.g., the amount of bandwidth needed to perform BDR on the determined memory partition candidates) and a total amount of available bandwidth to the processing circuitry 104 at the time of receiving the available bandwidth request 405. In some embodiments, traffic manager 408 may deny the allocation of bandwidth to perform BDR if there are higher priority tasks or operations for processing circuitry 104 to perform.

When the BDR manager 402 receives an available bandwidth response 407 granting the allocation of bandwidth for BDR, the BDR manager may relay signal 420 to bands manager 404 to indicate which of the memory partitions (e.g., memory bands 216, 218, 220, 222, 224, 226 or virtual block pools 302, 304, 306) are candidates for BDR, as determined by BDR manager 402. Additionally, the BDR manager 402 may transmit a credits signal 409 to one or more relocation managers 412, where the credits signal 409 includes a number of credits based on (1) the amount of allocated bandwidth for BDR, (2) the number of memory partitions (e.g., memory bands or virtual blocks) on which BDR is to be performed, (3) the size of the memory partition on which BDR is to be performed, (4) whether the device 102 is in block mode or FDP mode, and (5) preconfigured memory degradation policy (e.g., target refresh rate, NAND policy) requirements. In some embodiments, the number of credits issued and included in credits signal 409 indicates to the relocation managers 412 whether a particular memory partition candidate (i.e., a memory partition candidate with a large number of issued credits) should be prioritized when performing BDR. In some embodiments, the number of issued credits may be based on a time window to perform this the BDR for a memory partition (e.g., memory band in block mode or virtual block in FDP mode). For example, for a smaller time window, BDR manager 402 may issue more credits in credits signal 409. Additionally, the BDR manager 402 considers whether the device 102 is in block mode or FDP mode when issuing credits for a particular memory partition, as performing BDR on a memory band while in block mode takes fewer cycles than performing BDR on one or more virtual blocks in FDP mode. In some embodiments, each relocation manager 412 corresponds to a respective memory partition (e.g., a respective memory band (e.g., memory bands 216, 218, 220, 222, 224, and 226) when the device is in block mode or a respective one or more virtual blocks (e.g., virtual block pools 302, 304, and 306) when the device is in FDP mode).

Once the bands manager 404 receives signal 420 from BDR manager 402, bands manager 404 transmits a relocation request 415 to each relocation manager 415 that corresponds to the memory partition (e.g., memory band in block mode or virtual block in FDP mode) on which BDR is to be performed. When a respective relocation manager 412 receives a relocation request 415 from bands manager 404 and a credits signal 409 from BDR manager 402, the respective relocation manager may perform BDR on the respective corresponding memory partition by relocating the data stored within the memory partition to a different memory location within memory 105. When device 102 is in block mode, the relocation manager 412 may relocate the memory partition (e.g., a memory band of data) to a memory address of a new memory band. When the device 102 is in FDP mode, the relocation manager 412 may relocate the memory partition (e.g., virtual blocks of data) to one or more memory blocks across different memory bands (e.g., memory bands 216, 218, 220, 222, 224, and 226) and different memory dies (e.g., memory dies 202a, 202b, 202c, 202N). The BDR manager 402 is configured to, based on whether the device is in block mode or FDP mode, calculate the amount of data within a memory partition, whether the memory partition corresponds to a memory band in block mode or a virtual block in FDP mode. In some embodiments, once the relocation manager 412 performs BDR on the corresponding memory partition, relocation manager 412 may send an acknowledgment signal 411 to band manager 404, indicating that the BDR of the corresponding memory partition has been performed.

Processing circuitry 104 may also include overriding entity 414 (e.g., a host device), which may transmit a BDR disable signal 417 to cause the BDR manager to disable BDR. Performing BDR, as a memory management process, consumes resources (e.g., memory and bandwidth). Therefore, in some embodiments, device 102 may disable BDR to allocate bandwidth and other processing resources to perform other tasks or operations. In some embodiments, BDR manager 402 may transmit a BDR disable request 419 to overriding entity 414. In response to receiving the BDR disable request 419, the overriding entity may transmit BDR disable signal 417 to BDR manager 402. Even when BDR is disabled, BDR crawler 406 and bands manager 404 may still determine the metadata of each memory band and update information (e.g., score based on the parameters or statistics of the memory bands) of the memory bands, respectively. Furthermore, even when BDR is disabled, BDR manager 402 may still receive information 401.

In some embodiments when the device 102 is in block mode, BDR manager 402 may not select an otherwise eligible memory partition (e.g., a memory band) candidate on which to perform BDR if the memory band is open and the amount of data stored in the memory band does not satisfy a threshold value. Therefore, for a memory partition in block mode (e.g., a memory band) to be selected by BDR manager 402, the memory band may be required to satisfy the threshold related to the amount of data stored in the memory band. In some embodiments, the processing circuitry may include streams manager 416, which is configured to abort certain memory bands that are associated with memory partition candidates for BDR that do not satisfy the amount of stored data threshold value. In such embodiments, bands manager 404 may transmit an abort band signal 413 to streams manager 416 to cause the streams manager to write unrelated data (e.g., dummy data) for the amount of data stored in the memory band to exceed the threshold. Therefore, by aborting a memory band, streams manager 413 causes a previously open memory band that was ineligible for BDR to become eligible for BDR consideration.

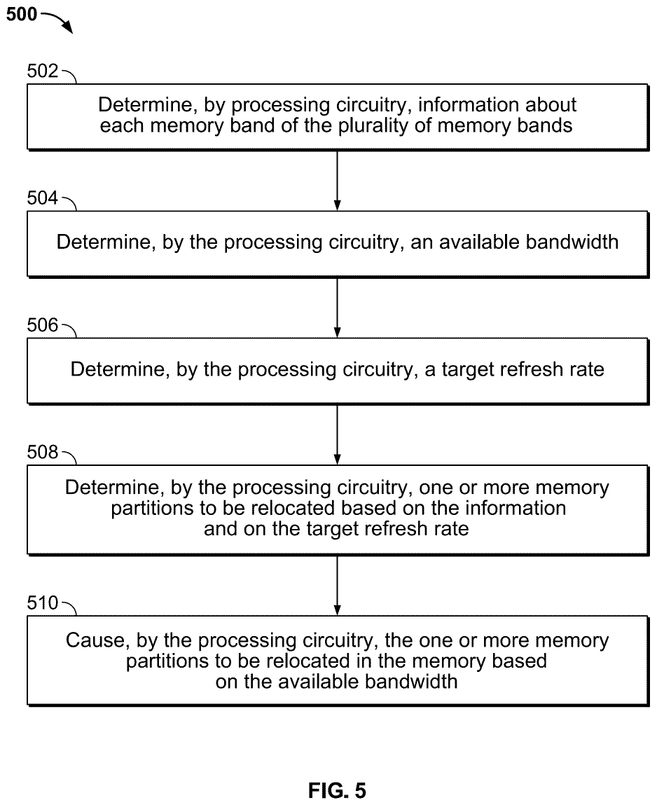

FIG. 5 shows a flowchart of illustrative steps of process 500 for performing background data refresh (BDR) for a device, in accordance with some embodiments of the present disclosure. In some embodiments, the referenced system, device, processing circuitry, memory, memory blocks, memory bands, memory dies, and virtual blocks may be implemented as system 100, device 102, processing circuitry 104, memory 105, memory blocks (e.g., memory blocks 204a-204N, 206a-206N, 208a-208N, 210a-210N, 212a-212N, 214a-214N), memory bands (e.g., memory bands 216, 218, 220, 222, 224, 226), memory dies (e.g., memory dies 202a, 202b, 202c, 202N), and virtual blocks (e.g., virtual block pools 302, 304, 306), respectively. In some embodiments, the process 500 can be modified by, for example, having steps rearranged, changed, added, and/or removed.

At step 502, the processing circuitry determines information about each memory band of the memory bands in the memory. Once the processing circuitry determines information about each memory band of the memory bands, the processing circuitry determines an available bandwidth, at step 504.

At step 504, processing circuitry determines an available bandwidth. Once the processing circuitry determines the available bandwidth, the processing circuitry then determines a target refresh rate, at 506.

At step 506, the processing circuitry determines a target refresh rate for the BDR of the device. Once the processing circuitry determines the target refresh rate, processing circuitry then determines one or more memory partitions to be relocated based on the information and on the target refresh rate, at 508.

At step 508, the processing circuitry determines one or more memory partitions to be relocated based on the information and the target refresh rate. Once the processing circuitry determines one or more memory partitions to be relocated, the processing circuitry then causes one or more memory partitions to be relocated in the memory based on the available bandwidth, at step 510.

At step 510, the processing circuitry causes one or more memory partitions to be relocated in the memory based on the available bandwidth. In some embodiments, processing circuitry performs write operations to relocate the data associated with the determined memory partitions to new memory locations within the memory.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A device comprising:
memory comprising a plurality of memory bands; and
processing circuitry to:
determine information about each memory band of the plurality of memory bands,
determine an available bandwidth,
determine a target refresh rate,
determine one or more memory partitions to be relocated based on the information and on the target refresh rate, and
cause the one or more memory partitions to be relocated in the memory based on the available bandwidth.

2. The device of claim 1, wherein the processing circuitry comprises:
a memory bands manager to determine information about each memory band of the plurality of memory bands; and
a background data refresh (BDR) manager to:
determine the available bandwidth,
determine the target refresh rate,
determine one or more memory partitions to be relocated based on the information and on the target refresh rate, and
cause the one or more memory partitions to be relocated in the memory based on the available bandwidth.

3. The device of claim 2, wherein the processing circuitry further comprises a traffic manager, and to determine the available bandwidth the BDR manager is to:
transmit, to the traffic manager, a request signal to determine the available bandwidth, and
receive, from the traffic manager, a response signal comprising the available bandwidth to relocate the one or more memory partitions to be relocated in memory.

4. The device of claim 1, wherein to determine information about each memory band of the plurality of memory bands, the processing circuitry is to:
gather memory band information corresponding to each respective memory band of the plurality of memory bands, and
determine the information about each memory band of the plurality of memory bands based on the memory band information of the respective memory band.

5. The device of claim 1, wherein the processing circuitry further comprises a relocation manager, and to cause the one or more memory partitions to be relocated in the memory based on the available bandwidth the processing circuitry is to:
for each respective memory block of the one or more memory partitions to be relocated, relocate data of the respective memory block to a respective new memory block address using the relocation manager.

6. The device of claim 1, wherein the information about each respective memory band of the plurality of memory bands comprises:
an age of data stored in the respective memory band,
a type of the data stored in the respective memory band, and
a maximum number of cycles for the respective memory band.

7. The device of claim 1, the device further comprising a timer module to periodically transmit a wakeup signal to processing circuitry and wherein the processing circuitry is further to:
receive the wakeup signal; and
in response to the receipt of the wakeup signal:
determine information about each memory band of the plurality of memory bands,
determine the available bandwidth,
determine the target refresh rate,
determine one or more memory partitions to be relocated based on the information and on the target refresh rate, and
cause the one or more memory partitions to be relocated in the memory based on the available bandwidth.

8. The device of claim 1, wherein:
each memory partition of the one or more memory partitions comprises a respective one or more memory bands, and
each of the respective one or more memory bands comprises one or more physical memory blocks.

9. The device of claim 1, wherein:
each memory partition of the one or more memory partitions comprises a respective one or more memory bands, and
each memory band of the respective one or more memory bands comprises one or more virtual memory blocks.

10. The device of claim 1, wherein the processing circuitry is further to:
determine whether a respective memory band of the plurality of memory bands is an open memory band by determining that the respective memory band stores less than a predetermined amount of data; and
in response to the determination that the respective memory band is an open memory band:
store additional data in unused portions of the respective memory band wherein, with the additional data, the respective memory band stores at least the predetermined amount of data.

11. The device of claim 1, wherein the processing circuitry is further to:
receive, from an overriding entity, a background data refresh (BDR) disable request; and
in response to the receipt of the BDR disable request:
cause to disable, from being relocated, the one or more memory partitions to be relocated in the memory based on the available bandwidth; and
transmit, to the overriding entity, a BDR disable response.

12. A method for performing background data refresh (BDR) for a device comprising processing circuitry and memory comprising a plurality of memory bands, the method comprising:
determining, by the processing circuitry, information about each memory band of the plurality of memory bands,
determining, by the processing circuitry, an available bandwidth,
determining, by the processing circuitry, a target refresh rate,
determining, by the processing circuitry, one or more memory partitions to be relocated based on the information and on the target refresh rate, and
causing, by the processing circuitry, the one or more memory partitions to be relocated in the memory based on the available bandwidth.

13. The method according to claim 12, wherein determining the available bandwidth comprises:
transmitting, to a traffic manager of the processing circuitry, a request signal to determine the available bandwidth, and
receiving, from the traffic manager, a response signal comprising the available bandwidth to relocate the one or more memory partitions to be relocated in memory.

14. The method according to claim 12, wherein determining the information about each memory band of the plurality of memory bands comprises:
gathering memory band information corresponding to each respective memory band of the plurality of memory bands, and
determining the information about each memory band of the plurality of memory bands based on the memory band information of the respective memory band.

15. The method according to claim 12, wherein causing the one or more memory partitions to be relocated in the memory based on the available bandwidth comprises:
relocating, for each respective memory block of the one or more memory partitions to be relocated, data of the respective memory block to a respective new memory block address using a relocation manager of the processing circuitry.

16. The method according to claim 12, wherein the information about each respective memory band of the plurality of memory bands comprises:
an age of data stored in the respective memory band,
a type of the data stored in the respective memory band, and
a maximum number of cycles for the respective memory band.

17. The method according to claim 12, further comprising:
periodically receiving, by processing circuitry and from a timer module of the device, a wakeup signal; and
in response to receiving the wakeup signal:
determining information about each memory band of the plurality of memory bands,
determining an available bandwidth,
determining a target refresh rate,
determining one or more memory partitions to be relocated based on the information and on the target refresh rate, and
causing the one or more memory partitions to be relocated in the memory based on the available bandwidth.

18. The method according to claim 12, wherein:
each memory partition of the one or more memory partitions comprises a respective one or more memory bands, and
each of the respective one or more memory bands comprises one or more physical memory blocks.

19. The method according to claim 12, wherein:
each memory partition of the one or more memory partitions comprises a respective one or more memory bands, and
each memory band of the respective one or more memory bands comprises one or more virtual memory blocks.

20. The method according to claim 12, further comprising:
determining whether a respective memory band of the plurality of memory bands is an open memory band by determining that the respective memory band stores less than a predetermined amount of data; and
in response to determining that the respective memory band is an open memory band:
storing additional data in unused portions of the respective memory band wherein, with the additional data, the respective memory band stores at least the predetermined amount of data.

21. The method according to claim 12, further comprising:
receiving, from an overriding entity, a BDR disable request; and
in response to receiving the BDR disable request:
causing to disable, from being relocated, the one or more memory partitions to be relocated in the memory based on the available bandwidth; and
transmitting, to the overriding entity, a BDR disable response.
